(19) United States
(12) Patent Application Publication
(10) Pub. No.: US 2006/0187193 A1
(43) Pub. Date: Aug. 24, 2006

(54) System and method for generating a virtual reality presentation

(76) Inventor: Eileen Caridad Esquilin, Secaucus, NJ (US)

Correspondence Address: KENYON & KENYON LLP, ONE BROADWAY, NEW YORK, NY, 10004, US

(21) Appl. No.: 11/063,907

(22) Filed: Feb. 22, 2005

(51) Int. Cl. G09G 5/00

(52) U.S. Cl. 345/156

(57) ABSTRACT

A system and method for generating a video presentation on a portable video data storage medium. The system includes one or more position sensors wearable by a person, the position sensors configured to move upon a movement of the person. The system also includes a computer system in communication with the one or more position sensors. The computer system is configured to generate a virtual image. The computer system is further configured to sense the movement of the position sensors and to move the virtual image in correspondence with the movement of the one or more position sensors. Also, the computer system is configured to store on the video data storage medium data corresponding to the moving virtual image. The portable video data storage medium may be a DVD, a video tape, a computer disk, etc., thereby enabling the portable video data storage medium to be subsequently viewed by a user at any desirable time in the future or to be presented as, e.g., a gift, to another.

### FIELD OF THE INVENTION

The present invention relates to a system and method for generating a virtual reality presentation. More specifically, the present invention relates to a system and method for generating a customized and personalized DVD presentation using virtual reality technology.

### BACKGROUND INFORMATION

Virtual reality is commonly employed in the entertainment industry to generate a video presentation. For instance, an actor may wear a virtual reality suit, which has numerous position sensors. As the actor moves, the position sensors worn by the actor also move. The movement of these position elements are sensed by a computer system, which then employs software to manipulate a video image. Typically, the video image is a virtual character, e.g., a character that is digitally added to a video presentation. Thus, the video image, such as a virtual character in the video display, may simulate the movements of the actor. In this way, the movements of the video image that are displayed in the video display look relatively realistic, because they closely represent the movements that a real actor has made.

One type of virtual reality system that is currently employed is referred to as video karaoke. In conventional video karaoke systems, a user wears a virtual reality suit having position sensors. Movements made by the user are sensed by the position sensors and a video image displayed on a display device of the system is caused to move in the same way as the position sensors worn by the user are caused to move. In addition, in conventional video karaoke systems, the lyrics of a song are also displayed on the video display. The conventional video karaoke systems include a microphone so that a user can sing the lyrics that are displayed. In this manner, a user's own voice and movements are amplified and displayed, respectively, on the video display.

One of the drawbacks of conventional virtual reality systems is that they do not generate a customizable and portable video presentation that can be enjoyed by a user repeatedly in the future. Furthermore, conventional virtual reality systems do not enable a user to generate such a video presentation on a selectable display medium, e.g., a DVD, a video tape, a computer disk, etc., that can be displayed when desired or that can be given to another, e.g., as a gift.

It is therefore an object of the present invention to provide a virtual reality system that generates a customizable and portable video presentation that can be enjoyed by a user repeatedly in the future. It is a further object of the present invention to provide a virtual reality system that enables a user to generate a video presentation on a selectable display medium, e.g., a DVD, a video tape, a computer disk, etc., that can be displayed when desired or that can be given to another, e.g., as a gift.

### SUMMARY OF THE INVENTION

The above and other beneficial objects of the present invention are achieved by providing a system and method as described herein. The present invention, according to one example embodiment thereof, relates to a system for generating a video presentation on a portable video data storage medium. The system may include one or more position sensors wearable by a person. The position sensors are configured to move upon a movement of the person. The system may include a computer system in communication with the one or more position sensors. The computer system is configured to generate a virtual image. Also, the computer system further is configured to sense the movement of the position sensors and to move the virtual image in correspondence with the movement of the one or more position sensors. Furthermore, the computer system is further configured to store on the video data storage medium data corresponding to the moving virtual image. The portable video data storage medium may be a DVD, a video tape, a computer disk, etc. In alternative embodiments, the system employs a predetermined or preselected animation character image that is moved in accordance with a predetermined or preselected type of presentation, e.g., a music video, a lullaby, a story, etc.

Advantageously, the system also includes a display device, wherein the virtual image is displayable on the display device. The virtual image may include an animated character. In one embodiment of the present invention, the system includes a user input device. In this embodiment, the virtual image may be selected by the person via the user input device from a plurality of virtual images stored in a virtual image data storage module. Furthermore, the virtual image may include a virtual background image. In another embodiment, the virtual background image may be selected by the person via the user input device from a plurality of virtual background images stored in a virtual background image data storage module.

Preferably, the system also includes a microphone in communication with the computer system, wherein the microphone is configured to process sounds made by the person. The computer system is also configured to store on the video data storage medium the sounds made by the person, e.g., voices that are talking, singing, etc.

The present invention is also directed, according to one embodiment thereof, to a method for generating a video presentation on a portable video data storage medium. Still further, the present invention is also directed, according to one embodiment thereof, to a portable video data storage medium that includes data corresponding to a moving virtual image, the moving virtual image corresponding to movements of a person, the moving virtual image generated and stored on the video storage medium by a computer system that is configured to sense the movement of one or more position sensors worn by a person and to move the virtual image in accordance with the movements of the one or more position sensors.

### BRIEF DESCRIPTION OF THE DRAWINGS

FIG. 1 is a block diagram that illustrates the system of the present invention, in accordance with one embodiment thereof;

FIG. 2 illustrates an image that may comprise a portion of a video presentation, according to one embodiment of the present invention;

FIG. 3 is a flowchart that illustrates generally the steps that are performed by the computer system 20, in accordance with one embodiment of the present invention;

FIG. 4 is a block diagram that illustrates the system of the present invention, in accordance with another and preferred embodiment thereof;

FIG. 5 illustrates an image that may comprise a portion of a video presentation, according to one embodiment of the present invention; and

FIG. 6 is a flowchart that illustrates generally the steps that are performed by the computer system 320, in accordance with one embodiment of the present invention.

FIG. 7 is a block diagram that illustrates the system of the present invention, in accordance with another embodiment thereof;

FIG. 8 illustrates an image that may comprise a portion of a video presentation, according to one embodiment of the present invention; and

FIG. 9 is a flowchart that illustrates generally the steps that are performed by a computer system, in accordance with one embodiment of the present invention.

### DETAILED DESCRIPTION

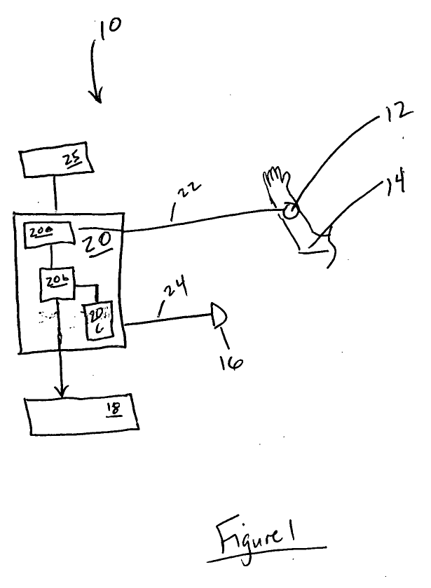

FIG. 1 is a block diagram that illustrates the system of the present invention, in accordance with one embodiment thereof. Specifically, FIG. 1 illustrates a virtual reality system 10 for generating a video presentation. The virtual reality system 10 includes one or more position sensors 12. The position sensors 12 are wearable by a person 14. The position sensors 12 are configured to move upon a movement of the person 14. For instance, the position sensors 12 may be incorporated into a virtual reality/motion capture suit that has one or more different position sensors embedded therein. The virtual reality system 10 also includes a microphone 16. The microphone 16 is configured to process sounds made by the person 14.

The virtual reality system 10 also includes a computer system 20. The computer system 20 is in communication with the position sensors 12, either via a wired 22 or wireless connection. Furthermore, the computer system 20 is in communication with the microphone 16, either via a wired 24 or wireless connection. The computer system 20 may be connected to and communicate with a data storage medium 18 for storing data thereon. The computer system 20 may be connected to and communicate with a user input device 25, such as a keyboard or the like.

The computer system 20 may be any combination of hardware and software capable of performing the functions described in detail below. For instance, in the embodiment shown in FIG. 1, the computer system 20 includes a sensing module 20a that senses the movement of the position sensors 12. The sensing module 20a provides data to a processor 20b that processes the data. In addition, the computer system 20 includes a virtual image data storage module 20c that stores data corresponding to a virtual image, e.g., one or more animated characters.

The data storage medium 18 may be any conceivable type of medium for storing data. For instance, the data storage medium 18 may be a DVD, a video tape, a computer disk, etc. Advantageously, the data storage medium 18 is a physically portable medium so that once data has been stored thereon, the data storage medium 18 may be removed from the computer system 20 by the user. In this manner, the user may play and re-play the video presentation stored on the data storage medium 18 on any suitable display device. In addition, the portability of the data storage medium enables a user to provide the video presentation stored on the data storage medium 18 to others, e.g., as a gift. Of course, non-portable types of data storage medium 18 may also be employed. For instance, a video presentation may be stored as data that can be e-mailed or otherwise transmitted to a display device. Still further, the data storage medium 18 may be any type of medium that employs or that includes a projector, a display device, a night light, etc., that is capable of providing a viewable image for a user or recipient. For instance, in one embodiment, the data storage medium includes a light that may shine through the medium and onto a child's bedroom wall, e.g. at bedtime, in order to provide a viewable presentation on the bedroom wall.

As set forth above, the virtual reality system 10 of the present invention, in accordance with one embodiment thereof, may be employed to generate a customizable video presentation on a portable data storage medium. The type of video presentation generated may be any type of video presentation. One such type of video presentation is an animated video presentation. An animated video presentation may include a plurality of video images, preferably in conjunction with sound that corresponds thereto. For the purposes of example only, the present invention will be described below in connection with the generation of an animated video presentation. It should be recognized, however, that any type of video presentation may be generated by the virtual reality system 10 of the present invention.

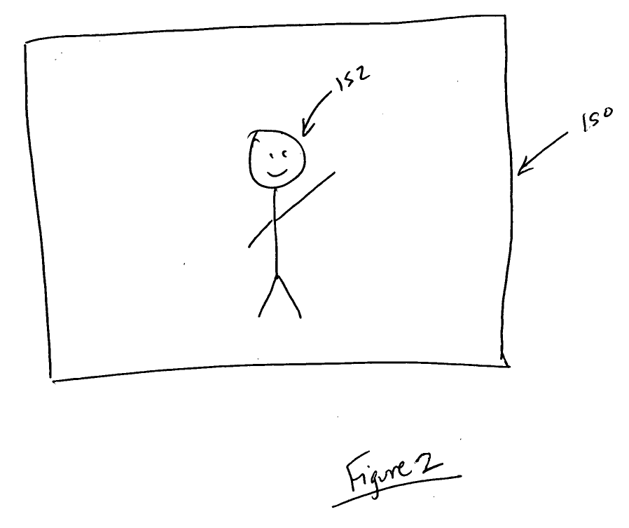

FIG. 2 illustrates an image that may comprise a portion of a video presentation, according to one embodiment of the present invention. For instance, FIG. 2 illustrates a video presentation image 150. This video presentation image 150 may comprise one video frame of an animated video presentation that includes a plurality of video frames. The video presentation image 150 advantageously includes at least one virtual image 152. The virtual image 152, as set forth above, is an image that is generated by the computer system 20 and that is caused to move during the animated video presentation in accordance with the movements sensed by the computer system 20.

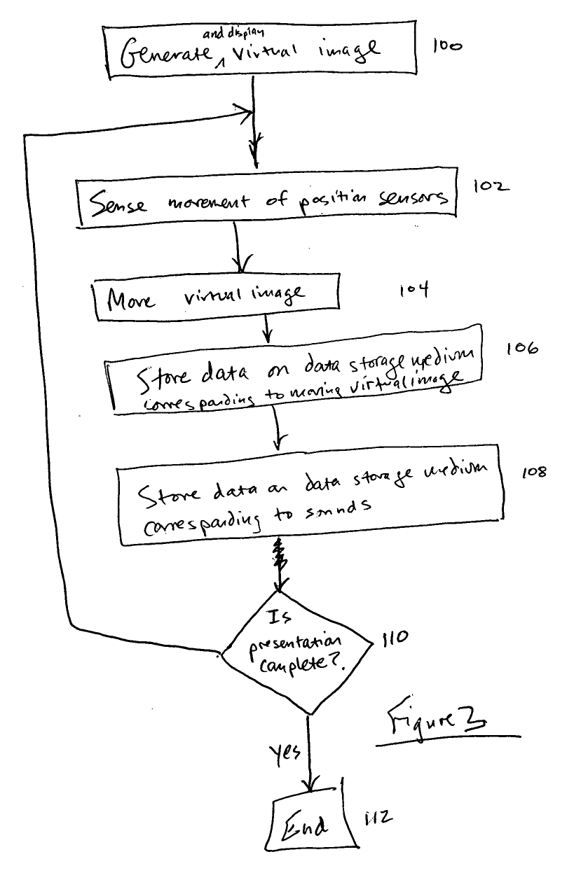

FIG. 3 is a flowchart that illustrates generally the steps that are performed by the computer system 20, in accordance with one embodiment of the present invention. At step 100, the computer system 20 generates a virtual image 152. The virtual image 152 may, according to one embodiment, be stored as data in the virtual image data storage module 20c. The virtual image 152 may be any type of image, e.g., an animated image, as set forth in greater detail below. For the purposes of example only, the virtual image 152 is described hereinafter as being an animated character. Advantageously, the virtual image 152 that is generated may be selected by a user. For instance, the computer system 20 may provide a user with a selection of various different animated characters, and a user may select his or her preference by entering a selection via the user input device 25. Also, at step 100, the computer system 20 may display the virtual image 152 on a display device.

At step 102, the computer system 20 senses the movement of the position sensors 12. For instance, if the person 14 raises her left hand and a position sensor 12 attached to or otherwise worn by the person 14 on her left hand is also caused to be raised, the raising movement of the position sensor 12 is sensed by the computer system 20.

At step 104, the computer system 20 moves the virtual image in correspondence with the movement of the position sensors 12. For instance, if as set forth above the computer system 20 senses that the position sensor 12 attached to or otherwise worn by the person 14 on her left hand has been raised, then the computer system 20 processes the video image 152 in a manner that corresponds to this sensed movement. In one embodiment wherein the virtual image 152 is an animated character, the computer system 20 may raise the left hand of the animated character.

At step 106, the computer system 20 stores on the data storage medium 18 data corresponding to the moved virtual image 152. In one embodiment, the moved virtual image 152 is simultaneously displayed on a display device so that the user can see in real-time how the moved virtual image 152 appears. At step 108, the computer system 20 stores data on the data storage medium 18 corresponding to the sounds made by the person 14. Advantageously, the computer system 20 is configured to store the sounds made by the person 14 on the data storage medium 18 so as to correspond in time with the data corresponding to the moved virtual image 152.

While it is preferred that the computer system 20 stores, at step 108, data on the data storage medium 18 corresponding to the sounds made by the person 14, it should be recognized that in other embodiments, the computer system 20 does not store data on the data storage medium 18 corresponding to the sounds made by the person 14. Rather, the virtual reality system 10 may be configured to store predetermined sounds, e.g., music, voices, etc., on the data storage medium 18. In this embodiment, the microphone 16 illustrated in FIG. 1 may be eliminated.

At step 110, the computer system 20 queries whether the presentation is complete. If the presentation is complete, then the computer system 20 proceeds to step 112, and ends. If the presentation is not complete, then the computer system 20 returns to step 102 to sense additional movement and to re-perform steps 102 through 110.

In the embodiment set forth above, the video presentation image 150 includes a single virtual image 152. It should be recognized that, in other embodiments, any number of virtual images 152 may be included. For instance, more than one user can wear virtual reality suits, each virtual reality suit having a different set of position sensors and facilitating the movement of more than one virtual images 152.

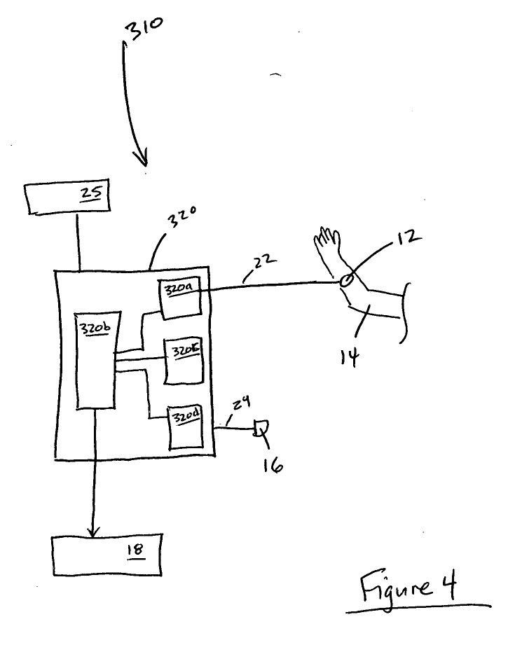

In other embodiments of the present invention, the video presentation image may also include background images. For instance, FIG. 4 is a block diagram that illustrates the system of the present invention, in accordance with another and preferred embodiment thereof. Specifically, FIG. 4 illustrates a system 310 for generating a video presentation. The virtual reality system 310 includes one or more position sensors 12. The position sensors 12 are wearable by a person 14. The position sensors 12 are configured to move upon a movement of the person 14. For instance, the position sensors 12 may be a virtual reality/motion capture suit that has one or more different position sensors embedded therein. The virtual reality system 310 may also include a microphone 16. The microphone 16 is configured to process sounds made by the person 14.

The virtual reality system 310 also includes a computer system 320. The computer system 320 is in communication with the position sensors 12, either via a wired 22 or wireless connection. Furthermore, the computer system 320 is in communication with the microphone 16, either via a wired 24 or wireless connection. The computer system 320 may communicate with a data storage medium 18 for storing data thereon.

The computer system 320 may be any combination of hardware and software capable of performing the functions described in detail below. For instance, in the embodiment shown in FIG. 4, the computer system 320 includes a sensing module 320a that senses the movement of the position sensors 12. The sensing module 320a provides data to a processor 320b that processes the data. In addition, the computer system 320 includes a virtual image data storage module 320c that stores data corresponding to a virtual image, e.g., one or more animated characters. In addition, the computer system 320 includes a virtual background image data storage module 320d that stores data corresponding to a virtual background image or images.

As set forth above, the data storage medium 18 may be any conceivable type of medium for storing data. For instance, the data storage medium 18 may be a DVD, a video tape, a computer disk, etc. Advantageously, the data storage medium 18 is a physically portable medium so that once data has been stored thereon, the data storage medium 18 may be removed from the computer system 320 by the user. In this manner, the user may play and re-play the video presentation stored on the data storage medium 18 on any suitable display device. In addition, the portability of the data storage medium enables a user to provide the video presentation stored on the data storage medium 18 to others, e.g., as a gift. Of course, non-portable types of data storage medium 18 may also be employed. For instance, a video presentation may be stored as data that can be e-mailed or otherwise transmitted to a display device. Still further, the data storage medium 18 may be any type of medium that employs or that includes a projector, a display device, a night light, etc., that is capable of providing a viewable image for a user or recipient. For instance, in one embodiment, the data storage medium includes a light that may shine through the medium and onto a child's bedroom wall, e.g. at bedtime, in order to provide a viewable presentation on the bedroom wall.

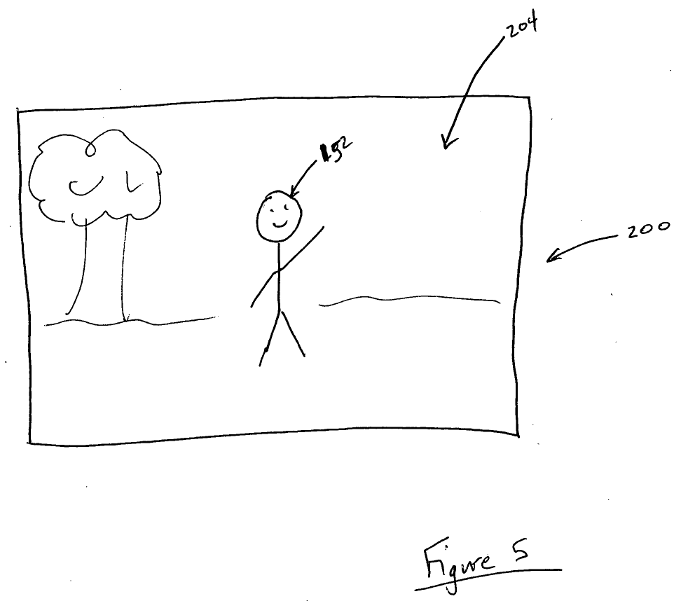

FIG. 5 illustrates an image that may comprise a portion of a video presentation, according to one embodiment of the present invention. For instance, FIG. 5 illustrates a video presentation image 200. This video presentation image 200 may comprise one video frame of an animated video presentation that includes a plurality of video frames. The video presentation image 200 advantageously includes at least one virtual image 152. The virtual image 152, as set forth above, is an image that is generated by the computer system 320 and that is caused to move during the animated video presentation in accordance with the movements sensed by the computer system 320.

In addition, the video presentation image 200 advantageously includes at least one virtual background image 204. The virtual background images 204 may be any images that are not virtual images 152, e.g., any images that do not move in accordance with the movement of the position sensors 12. It should be recognized that the virtual background images 204 may be moving or non-moving, based upon the video presentation desired. Also, it should be recognized that the virtual background images 204 may, according to one embodiment of the present invention, be selectable by a user via the user input device 25.

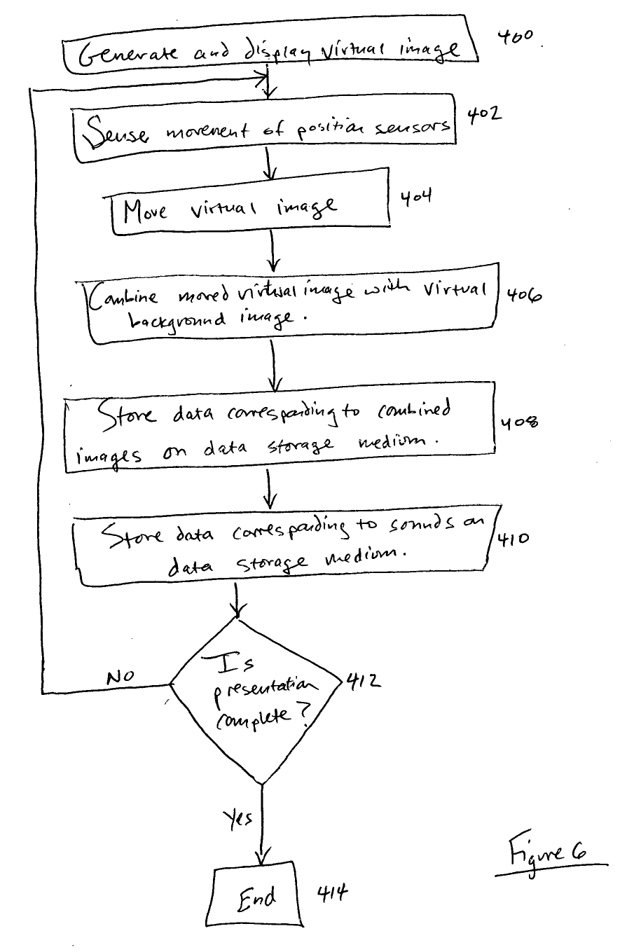

FIG. 6 is a flowchart that illustrates generally the steps that are performed by the computer system 320, in accordance with one embodiment of the present invention. At step 400, the computer system 320 generates a virtual image 152. The virtual image 152 may, according to one embodiment, be stored as data in the virtual image data storage module 320c. The virtual image 152 may be any type of image, e.g., an animated image, as set forth in greater detail below. For the purposes of example only, the virtual image 152 is described hereinafter as being an animated character. Advantageously, the virtual image 152 that is generated may be selected by a user. For instance, the computer system 320 may provide a user with a selection of various different animated characters, and a user may select his or her preference by entering a selection via the user input device 25. Also, at step 400, the computer system 320 may display the virtual image 152 on a display device.

At step 402, the computer system 320 senses the movement of the position sensors 12. For instance, if the person 14 raises her left hand and a position sensor 12 attached to or otherwise worn by the person 14 on her left hand is also caused to be raised, the raising movement of the position sensor 12 is sensed by the computer system 320.

At step 404, the computer system 320 moves the virtual image 152 in correspondence with the movement of the position sensors 12. For instance, if as set forth above the computer system 320 senses that the position sensor 12 attached to or otherwise worn by the person 14 on her left hand has been raised, then the computer system 320 processes the video image 152 in a manner that corresponds to this sensed movement. In one embodiment wherein the virtual image 152 is an animated character, the computer system 320 may raise the left hand of the animated character.

At step 406, the computer system 320 combines the moved virtual image 152 with an appropriate background image. As set forth above, the background image may be a virtual background image 204 that may or may not be selectable by a user via the user input device 25. Advantageously, the computer system 320 employs software that determines what portion of the virtual background image 204 is hidden behind the virtual image 152. Thus, when the computer system 320 combines the moved virtual image 152 with the virtual background image 204 at step 406, the resulting combined video image, e.g., virtual image 200, includes the virtual image 152, along with the background image 204, wherein the background image 204 fills the display in all locations other than those portions of the display occupied by the virtual image 152.

At step 408, the computer system 320 stores on the data storage medium 18 data corresponding to the combined virtual image 200. At step 410, the computer system 320 stores data on the data storage medium 18 corresponding to the sounds made by the person 14. Advantageously, the computer system 320 is configured to store the sounds made by the person 14 on the data storage medium 18 so as to correspond in time with the data corresponding to the combined virtual image 200.

While it is preferred that the computer system 320 stores, at step 410, data on the data storage medium 18 corresponding to the sounds made by the person 14, it should be recognized that in other embodiments, the computer system 320 does not store data on the data storage medium 18 corresponding to the sounds made by the person 14. Rather, the virtual reality system 310 may be configured to store predetermined sounds, e.g., music, voices, etc., on the data storage medium 18. In this embodiment, the microphone 16 illustrated in FIG. 4 may be eliminated.

At step 412, the computer system 320 queries whether the presentation is complete. If the presentation is complete, then the computer system 320 proceeds to step 414, and ends. If the presentation is not complete, then the computer system 320 returns to step 402 to sense additional movement and to re-perform steps 402 through 412.

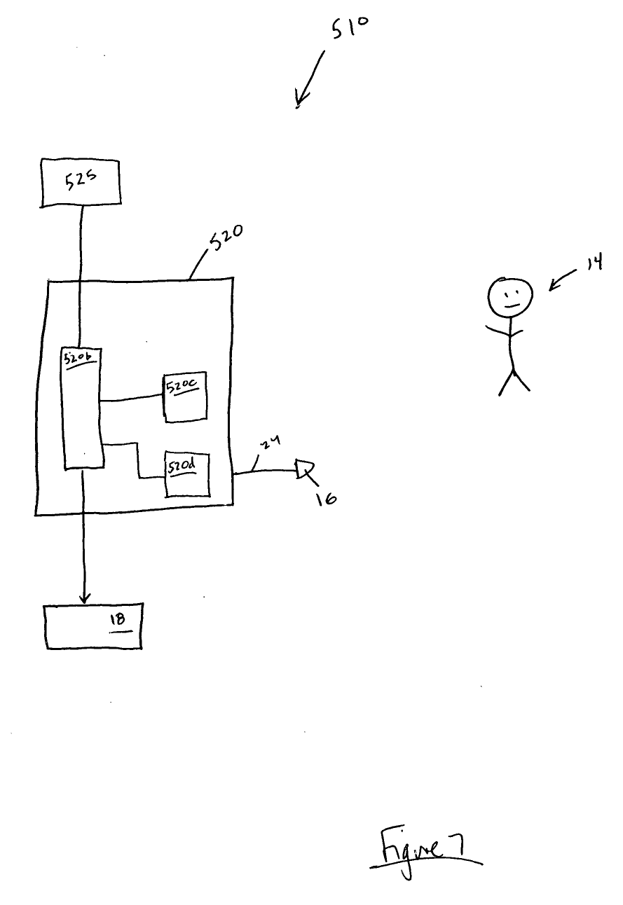

It should be recognized that, in other embodiments of the present invention, there may be provided a customizable and portable video presentation that does not employ a virtual reality arrangement. For instance, FIG. 7 is a block diagram that illustrates the system of the present invention, in accordance with one such embodiment thereof. Specifically, FIG. 7 illustrates a system 510 for generating a video presentation. The system 510 may include a microphone 16. The microphone 16 is configured to process sounds made by the person 14.

The system 510 also includes a computer system 520. The computer system 520 is in communication with the microphone 16, either via a wired 24 or wireless connection. The computer system 520 may communicate with a data storage medium 18 for storing data thereon.

The computer system 520 may be any combination of hardware and software capable of performing the functions described in detail below. For instance, in the embodiment shown in FIG. 7, the computer system 520 includes a processor 520b that processes data. The processor 520b may be connected to and communicate with a user interface module 525. In addition, the computer system 520 includes an animation image data storage module 520c that stores data corresponding to an animation image, e.g., one or more animated or cartoon-like characters. In addition, the computer system 520 includes an animation background image data storage module 520d that stores data corresponding to an animation background image or images.

As set forth above, the data storage medium 18 may be any conceivable type of medium for storing data. For instance, the data storage medium 18 may be a DVD, a video tape, a computer disk, etc. Advantageously, the data storage medium 18 is a physically portable medium so that once data has been stored thereon, the data storage medium 18 may be removed from the computer system 520 by the user. In this manner, the user may play and re-play the video presentation stored on the data storage medium 18 on any suitable display device. In addition, the portability of the data storage medium enables a user to provide the video presentation stored on the data storage medium 18 to others, e.g., as a gift. Of course, non-portable types of data storage medium 18 may also be employed. For instance, a video presentation may be stored as data that can be e-mailed or otherwise transmitted to a display device. Still further, the data storage medium 18 may be any type of medium that employs or that includes a projector, a display device, a night light, etc., that is capable of providing a viewable image for a user or recipient. For instance, in one embodiment, the data storage medium includes a light that may shine through the medium and onto a child's bedroom wall, e.g. at bedtime, in order to provide a viewable presentation on the bedroom wall.

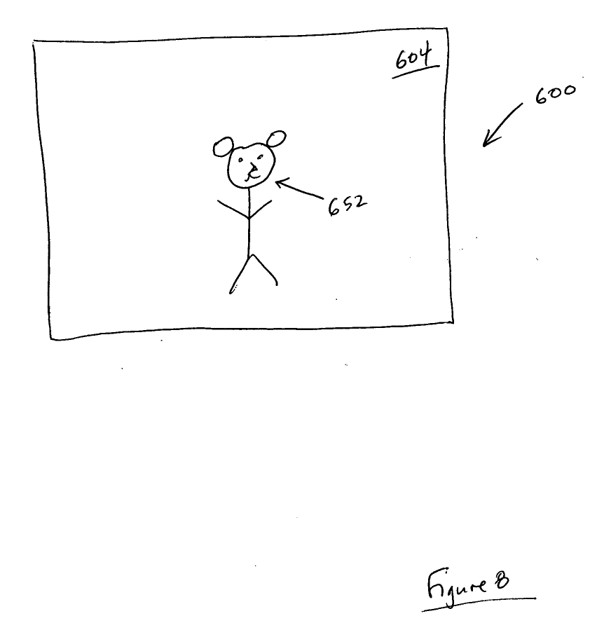

FIG. 8 illustrates an image that may comprise a portion of a video presentation, according to one embodiment of the present invention. For instance, FIG. 8 illustrates a video presentation image 600. This video presentation image 600 may comprise one video frame of an animated video presentation that includes a plurality of video frames. The video presentation image 600 advantageously includes at least one animation character image 652. The animation character image 652 is an image that is generated by the computer system 520 and that is caused to move during the animated video presentation in accordance with, e.g., user preferences provided by the user via the user interface module 525 and processed by the computer system 520. The animation character image 652 may, according to one embodiment of the present invention, be selectable by a user via the user interface module 525 from a plurality of possible animation characters, e.g., Mickey Mouse™, Spongebob Squarepants™, etc.

In addition, the video presentation image 600 advantageously includes at least one animation background image 604. The animation background images 604 may be any images that are not animation character images 652, e.g., any images that are not defined characters such as Mickey Mouse™, Spongebob Squarepants™, etc. It should be recognized that the animation background images 604 may be moving or non-moving, based upon the video presentation desired. Also, it should be recognized that the animation background images 604 may, according to one embodiment of the present invention, be selectable by a user via the user interface module 525.

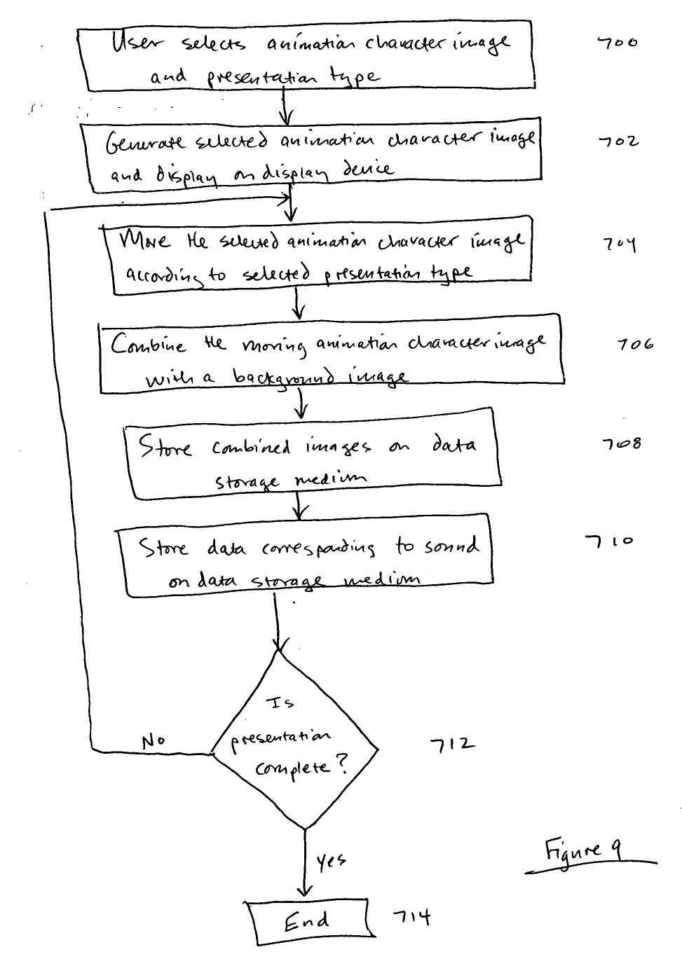

FIG. 9 is a flowchart that illustrates generally the steps that are performed by the computer system 520, in accordance with this embodiment of the present invention. At step 700, an animation character image 652 is selected by a user. For instance, the computer system 520 may provide a user with a selection of various different animated cartoon characters, and a user may select his or her preference by entering a selection via the user interface module 525. In addition, at step 700, the user may enter a selection corresponding to a presentation type, e.g., a music video, a lullaby, etc., as well as a background image desired to be displayed with the animation character image 652.

At step 702, the computer system 520 generates the selected animation character image 652. The animation character image 652 may, according to one embodiment, be stored as data in the animation image data storage module 320c. The animation character image 652 may be any type of image, e.g., an animated cartoon image, as set forth in greater detail below. For the purposes of example only, the animation character image 652 is described hereinafter as being an animated cartoon character, and specifically Spongebob Squarepants. Also, at step 702, the computer system 520 may display the animation character image 652 on a display device.

At step 704, the computer system 520 moves the animation character image 652 according to the presentation type selected by the user in step 700. For instance, if the user selected at step 700 a particular lullaby, then the computer system 520 may move the animation character image 652, e.g., Spongebob Squarepants, in a predetermined manner corresponding to the particular selected lullaby.

At step 706, the computer system 520 combines the moved animation character image 652 with an appropriate background image. As set forth above, the background image may be an animated background image 604 that may or may not be selectable by a user via the user interface module 525 at step 700. Advantageously, the computer system 520 employs software that determines what portion of the virtual background image 604 is hidden behind the animation character image 652. Thus, when the computer system 520 combines the moved animation character image 652 with the animation background image 604 at step 706, the resulting combined video image, e.g., image 600, includes the animation character image 652, along with the background image 604, wherein the background image 604 fills the display in all locations other than those portions of the display occupied by the animation character image 652.

At step 708, the computer system 520 stores on the data storage medium 18 data corresponding to the combined video image 600. At step 710, the computer system 520 stores data on the data storage medium 18 corresponding to the sounds made by the person 14. Advantageously, the computer system 520 is configured to store the sounds made by the person 14 on the data storage medium 18 so as to correspond in time with the data corresponding to the combined virtual image 600.

While it is preferred that the computer system 520 stores, at step 710, data on the data storage medium 18 corresponding to the sounds made by the person 14, it should be recognized that in other embodiments, the computer system 520 does not store data on the data storage medium 18 corresponding to the sounds made by the person 14. Rather, system 510 may be configured to store predetermined sounds, e.g., music, voices, etc., on the data storage medium 18. In this embodiment, the microphone 16 illustrated in FIG. 7 may be eliminated. It should also be recognized that, in other embodiments, the recording of sounds, and the storing of the sounds on the data storage medium 18, may occur before, during or after the storage of the image data on the data storage medium 18.

At step 712, the computer system 520 queries whether the presentation is complete. If the presentation is complete, then the computer system 520 proceeds to step 714, and ends. If the presentation is not complete, then the computer system 520 returns to step 704 to continue moving the selected animation character image 652 and to re-perform steps 704 through 712.

One of the drawbacks of conventional virtual reality systems is that they do not generate a customizable and portable video presentation that can be enjoyed by a user repeatedly in the future. Furthermore, conventional virtual reality systems do not enable a user to generate such a video presentation on a selectable display medium, e.g., a DVD, a video tape, a computer disk, etc., that can be displayed when desired or that can be given to another, e.g., as a gift. For instance, the present invention, in accordance with various embodiments thereof, can be made by parents or other family members or friends, and can be given to a child, thereby providing an ideal form of entertainment for that child even if the parents, family members or friends can not be present with the child. In this manner, the child can view a video presentation that was previously made by the parent, family member or friend and that may include the voices or sounds made by the parent, family member or friend. Of course, it should be recognized that the video presentation may be made, provided to and viewed by any person, not merely family members and friends, and that the subject matter of the video presentation may be for any conceivable purpose, including entertainment, promoting a commercial product or service, educational, etc.

Thus, the several aforementioned objects and advantages of the present invention are most effectively attained. Those skilled in the art will appreciate that numerous modifications of the exemplary example embodiments described hereinabove may be made without departing from the spirit and scope of the invention. Although various exemplary example embodiments of the present invention have been described and disclosed in detail herein, it should be understood that this invention is in no sense limited thereby and that its scope is to be determined by that of the appended claims.

What is claimed is:

1. A system for generating a video presentation on a portable video data storage medium, comprising:
one or more position sensors wearable by a person, the position sensors configured to move upon a movement of the person; and
a computer system in communication with the one or more position sensors, the computer system configured to generate a virtual image, the computer system further configured to sense the movement of the position sensors and to move the virtual image in correspondence with the movement of the one or more position sensors, the computer system further configured to store on the portable video data storage medium data corresponding to the moving virtual image.

2. The system of claim 1, wherein the portable video data storage medium is one of a DVD, a video tape, a computer disk, a projector and a night light.

3. The system of claim 1, further comprising a display device, wherein the virtual image is displayable on a display device.

4. The system of claim 1, wherein the virtual image includes an animated character.

5. The system of claim 4, further comprising a user input device, wherein the virtual image is selected by the person via the user input device from a plurality of virtual images stored in a virtual image data storage module.

6. The system of claim 1, wherein the virtual image includes a virtual background image.

7. The system of claim 6, further comprising a user input device, wherein the virtual background image is selected by the person via the user input device from a plurality of virtual background images stored in a virtual background image data storage module.

8. The system of claim 1, further comprising a microphone in communication with the computer system, wherein the microphone is configured to process sounds made by the person, the computer system being configured to store on the video data storage medium the sounds made by the person.

9. A method for generating a video presentation on a portable video data storage medium comprising the steps of:
fixing to a person one or more position sensors;
generating via a computer system a virtual image;
upon the person moving, sensing via the computer system the movement of the one or more position sensors and moving the virtual image in correspondence with the movement of the one or more position sensors;
storing on the portable video data storage medium data corresponding to the moving virtual image.

10. The method of claim 9, wherein the portable video data storage medium is one of a DVD, a video tape, a computer disk, a projector and a night light.

11. The method of claim 9, further comprising the step of displaying the virtual image on a display device.

12. The method of claim 9, wherein the virtual image includes an animated character.

13. The method of claim 12, further comprising the step of selecting the virtual image via a user input device from a plurality of virtual images stored in a virtual image data storage module.

14. The method of claim 9, wherein the virtual image includes a virtual background image.

15. The method of claim 14, further comprising the step of selecting the virtual background image via a user input device from a plurality of virtual background images stored in a virtual background image data storage module.

16. The method of claim 9, further comprising the steps of:
arranging a microphone in communication with the computer system;
processing via the microphone sounds made by the person;
storing on the video data storage medium the sounds made by the person.

17. A portable video data storage medium comprising:
data corresponding to a moving virtual image, the moving virtual image corresponding to movements of a person, the moving virtual image generated and stored on the video storage medium by a computer system that is configured to sense the movement of one or more position sensors worn by a person and to move the virtual image in accordance with the movements of the one or more position sensors.

18. The video data storage medium of claim 17, wherein the portable data storage medium is one of a DVD, a video tape, a computer disk, a projector and a night light.

19. The video data storage medium of claim 17, wherein the virtual image includes an animated character.

20. The video data storage medium of claim 17, wherein the virtual image includes a virtual background image.
